(19) United States
(12) Patent Application Publication
(10) Pub. No.: US 2026/0099137 A1
(43) Pub. Date: Apr. 9, 2026

(54) GENERATING ADDITIONAL SAMPLES FOR INDUSTRIAL PROCESSES

(71) Applicant: Honeywell International Inc., Charlotte, NC (US)

(72) Inventors: Sahil Vartak, Atlanta, GA (US); Junda Zhu, Atlanta, GA (US); Sabina Azizli, Fulshear, TX (US); Mitchell O'Brien, Tempe, AZ (US)

(73) Assignee: Honeywell International Inc., Charlotte, NC (US)

(21) Appl. No.: 18/909,732

(22) Filed: Oct. 8, 2024

(51) Int. Cl. G05B 19/418

(52) U.S. Cl. CPC G05B 19/4184; G05B 19/41875

(57) ABSTRACT

Systems and methods for generating additional samples for industrial processes are described herein. In certain embodiments, a system includes a memory configured to store a model associated with a physical process, wherein the model is configured to receive one or more input values and provide one or more output values, wherein the input values represent potential input parameters for the physical process and the output values represent potential measures of process information. The system also includes one or more processors executing computer executable instructions that cause the processors to receive the input values; generate the output values by executing the model using the input values as model inputs; provide the output values to replace one or more measures based on samples acquired from the physical process; and analyze the physical process based on the output values.

### BACKGROUND

Many industries rely on processes to produce valuable products. To ensure the quality of the outputs and the efficiency of the processes, the outputs, inputs, intermediate steps, and other portions of the process can be sampled to produce measurable data. For example, oil companies implement processes to refine crude oil into multiple petroleum products. These processes can be sampled to verify that they are working as desired. These samples are often provided to laboratories, where individuals then analyze information derived from the samples to verify that the process satisfies desired performance indicators. They can also analyze the samples to identify changes in the process, how to adjust process parameters, and other information that can be used to perform process optimization.

### SUMMARY

Systems and methods for generating additional samples for industrial processes are described herein. In certain embodiments, a system includes a memory configured to store a model associated with a physical process, wherein the model is configured to receive one or more input values and provide one or more output values, wherein the one or more input values represent potential input parameters for the physical process and the one or more output values represent potential measures of process information. The system also includes one or more processors executing computer executable instructions that cause the one or more processors to receive the one or more input values; generate the one or more output values by executing the model using the one or more input values as model inputs; provide the one or more output values to replace one or more measures based on samples acquired from the physical process; and analyze the physical process based on the one or more output values.

### BRIEF DESCRIPTION OF THE DRAWINGS

Drawings accompany this description and depict only some embodiments associated with the scope of the appended claims. Thus, the described and depicted embodiments should not be considered limiting in scope. The accompanying drawings and specification describe the exemplary embodiments, and features thereof, with additional specificity and detail, in which:

FIG. 1 is a block diagram illustrating a system for acquiring measurements from a process and performing analysis on the acquired measurements according to an aspect of the present disclosure;

FIG. 2 is an illustration of a table containing various measurements and parameters that are associated with process analysis according to an aspect of the present disclosure;

FIG. 3 is a flowchart diagram of a method for preparing a model for generated samples for use in subsequent process analysis according to an aspect of the present disclosure;

FIG. 4 is a flowchart diagram of a method for using generated samples for use in process analysis according to an aspect of the present disclosure; and

FIG. 5 is a flowchart diagram of a method for generating additional samples for industrial processes according to an aspect of the present disclosure.

Per common practice, the drawings do not show the various described features according to scale, but the drawings show the features to emphasize the relevance of the features to the example embodiments.

### DETAILED DESCRIPTION

The following detailed description refers to the accompanying drawings that form a part of the present specification. The drawings, through illustration, show specific illustrative embodiments. However, it is to be understood that other embodiments may be used and that logical, mechanical, and electrical changes may be made.

Systems and methods described herein are drawn to using models to generate additional samples for industrial processes. In certain embodiments, models may be created that reflect industrial processes. The industrial processes may have one or more controllable process parameters, and data representing the process parameters may be provided as inputs to the model. The model may generate outputs based on the input data representing expected samples. The generated outputs may then replace sample information when analyzing the physical process.

In typical embodiments, samples can be acquired from processes to determine how well an industrial process meets certain performance indicators, the current state of the process, parameter changes, and other control changes that an operator can make to further optimize the process, among other information that characterizes a process. In the ideal situation, samples are acquired with enough frequency so that the measurements from the samples accurately reflect the state of the industrial process at the time the samples are acquired. For example, samples can be acquired from a process periodically at a sufficient rate that analysis can be performed with confidence that the samples represent the process.

However, samples are often acquired from the process sporadically or periodically at less frequently than desired rates. For example, the most recently acquired samples may be acquired at sufficiently different times such that the samples represent different states of the process. Also, samples may become stale or old when trying to identify the current state of the process. As used herein, a sample becomes stale when sufficient time has passed since the sample acquisition such that there is lower confidence in the data accurately representing the current state of the sampled process. Using stale values by test engineers and others analyzing the process may negatively affect the accuracy of the subsequently performed analysis.

In certain embodiments described herein, the accuracy of the analysis may be improved by replacing stale values with predicted values. For example, process analysts may acquire multiple sample measurements representing different states acquired at different times and at different steps within the process. As some of the sample measurements become stale, the process analysts may identify the stale sample measurements and replace the sample measurements with predicted measurements that are more likely to represent actual process states, leading to improvements in the process analysis.

In further embodiments, known process information may be provided as inputs to a measurement prediction model to predict the new measurements. As used herein, process information refers to information that characterizes an industrial process or quantitatively represents aspects of the process. For example, the process information may include previously acquired sample measurements, known process parameters, time information, and other types of process information. In response to receiving the process information as inputs, the measurement prediction model generates predicted sample measurements as outputs. Using the predicted sample measurements, process analysis proceeds by replacing identified stale measurements with the predicted sample measurements. Accordingly, the use of predicted sample measurements in place of stale measurements (or even missing measurements) enables the performance of process analysis to more accurately represent the associated process.

In additional embodiments, to create the measurement prediction model that predicts measurements that are improvements on stale samples, machine learning algorithms may be employed to train the measurement prediction model. After the measurement prediction model is trained, the trained measurement prediction model may be deployed into an environment where users can input the process information and receive the predicted outputs from the measurement prediction model. For example, the measurement prediction model may be deployed to a cloud environment accessible by multiple users or deployed to a locally hosted environment. When the measurement prediction model is deployed and used within process analysis environments, additional samples acquired from the actual process, predictions from the deployed model, process parameters, and other process data may be provided to those who created the model for additional validation of the model and other methods to improve the accuracy of predictions generated from the measurement prediction model and the quality of process analysis performed using predicted measurements.

When training the measurement prediction model, data scientists may train the measurement prediction model to predict measurements for a specific process or domain-specific class of processes. For example, when training the measurement prediction model to be applicable to a specific process or domain-specific class of processes, a data scientist or group of data scientists may gather historical data produced from a specific process, similar processes, or other process in a particular industry domain. Examples of historical data may include process parameters, measurements, and time information associated with the process. As the historical data is from a specific process, similar processes, or a particular industry domain, the resultant model will predict measurements that are likely to be relevant to a particular process or group of processes.

In alternative embodiments, data scientists may train the measurement prediction model to predict measurements for a general class of processes. For example, when training the measurement prediction model to be applicable to a general class of processes, data scientists may acquire historical data from a wide class of processes or processes from multiple industry domains. As the historical data is from a wide class of processes or from multiple industry domains (e.g., from more domains that include oil refining, pharmaceutical, chemical engineering, mining, and the like), the resultant measurement prediction model may produce generalized measurement predictions.

In some embodiments, the measurement prediction model may be drawn to predict measurements about compositions of products produced and processed by a manufacturing process. When producing measurements for multiple compositions or outputs, different models may be trained to predict each output. For example, an oil refinery may employ a process that produces multiple products as outputs, and a separate model may be trained for each output. Thus, each prediction model may provide a single measurement or performance indicator. After training each model for the separate outputs, the different models may be combined together using various model combination methods. For example, the separate prediction models may be trained using an ensemble tree-based method or other method that is suitable for the specific measurement or performance indicator being predicted. When the multiple models have been trained, an ensemble tree-based method or other combining method may be used to combine the separate prediction models into a single measurement prediction model. Alternatively, the training data set may be drawn to train a single model to predict multiple measurements without training multiple measurement-specific models. Further, the measurement prediction model may be trained to provide a vector output of multiple measurement predictions or other outputs capable of conveying predictions related to multiple measurements. For example, the measurement prediction model may be a recurrent convolution network, a feed-forward neural network, or other capable model type.

Further, some processes may be based on physical laws of nature. For example, the measurement prediction model may be trained using first-principle-based training methods. Accordingly, known laws of nature and principles can be used with machine learning algorithms to increase the accuracy of the measurement prediction model. In particular, during training, the outputs provided by the measurement prediction model may be constrained to comport with what is physically possible based on the inputs provided to the model.

After deployment, the measurement prediction model may be used to provide measurement predictions to replace stale data. However, whenever new real measurements are received, the measurements, time, and process parameters at the time the measurement was acquired can be used as inputs to further validate the measurement prediction model. Additionally, the model may be validated by comparing the predictions against the use of the stale measurement data when new samples are received. Further, when deployed, the predicted measurements can be subjected to first-principle-based calculations for additional validation of the model. As the model is subject to post-deployment validation, the model can become increasingly accurate as it is used. Thus, a measurement prediction model may be used to generate measurements that more accurately reflect the state of a process, increasing the accuracy of analysis performed on measurement information.

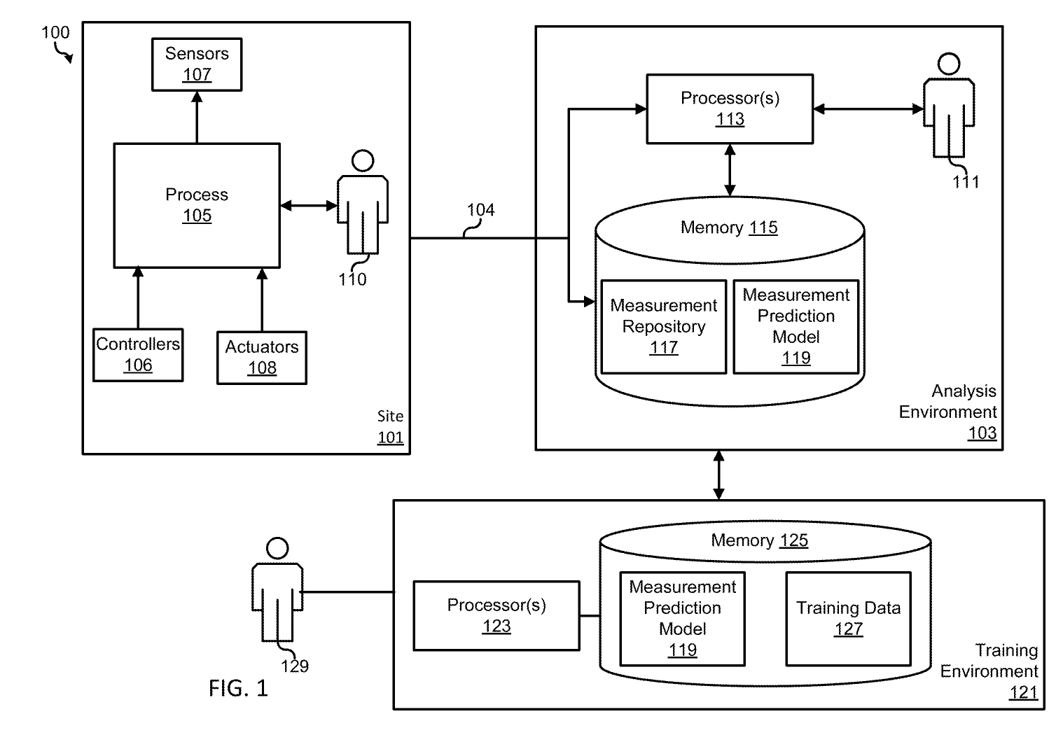

FIG. 1 is a block diagram illustrating a system 100 for acquiring measurements from an industrial process 105 performed at a site 101 and performing analysis on the acquired measurements within an analysis environment 103. As illustrated, the system 100 includes a site 101, where the site 101 may be a location where an industrial process 105 is performed. Alternatively, the site 101 may refer to multiple locations where portions of the industrial process 105 are performed at the multiple locations. Often times measurements of the industrial process 105 are performed at the site 101 and provided to the analysis environment 103. Within the analysis environment 103, the measurements from the industrial process 105 are analyzed to determine whether the industrial process 105 is operating as designed and also to see where improvements can be made to the industrial process 105. In certain embodiments, a site 101 may include components for performing multiple industrial processes 105. In some instances, a site that performs a process may be referred to collectively as an industrial process system, where a process system generally represents any system or portion thereof configured to process one or more products or other materials in some manner.

In embodiments described herein, an industrial process 105 refers to a series of steps performed using various components and materials, where the steps facilitate the production of a valuable product or the performance of a service that involves the transformation or processing of raw materials. Examples of industries that employ industrial processes 105 include mining, oil refining, pharmaceuticals, and many other industries. For instance, in industries generally, tasks performed as part of the industrial process 105 may include material processing, surface treatments, process controls and automation, quality management, logistics, and other industrial tasks. In particular, when the industrial process 105 includes material processing tasks, the industrial process 105 may include tasks that shape materials. Shaping tasks may include casting and molding tasks (where materials are shaped by pouring liquid materials into molds, forming tasks (where materials are shaped through deformation), Machining tasks (where materials are shaped through removing material), joining tasks (where materials are shaped by joining different objects together), and the like. Additionally, when the industrial process 105 includes surface treatment tasks, the industrial process 105 may include tasks that affect the surface of materials. Surface treatment tasks may include coating tasks (where layers are applied to material to protect and decorate an external surface), heat treating tasks (where surface properties are altered through controlled heating and cooling), and the like. Further, when the industrial process 105 includes process controls and automation tasks, the industrial process 105 may include tasks that monitor and configure other process steps. Process controls and automation tasks include sensing tasks (where process variables are monitored), controlling tasks (where systems that control other process tasks are configured), and the like. Moreover, when the industrial process 105 includes quality management tasks, the industrial process 105 may include tasks that monitor and control the quality of tasks performed as part of the industrial process 105. Quality control tasks include assurance tasks (where activities are performed to ensure quality requirements are met), control tasks (where activities are performed to fulfill quality requirements), compliance tasks (where activities are performed to ensure the industrial process 105 adheres to specified regulations), and the like. Also, when the industrial process 105 includes logistic tasks, the industrial process 105 may include tasks that control the movement and distribution of materials for the performance of other process steps. Logistic tasks include procuring tasks (where materials are acquired from other sources for the performance of other tasks), inventory managing tasks (where activities are performed for controlling the amount of materials in the process), distributing tasks (where activities are performed to control the movement of materials involved in the process and the distribution of finished products to customers), and the like. Examples of industries that perform industrial processes, such as those described above, may include oil-refining industries, pharmaceutical industries, mining industries, power providers, and many other industries that produce products or refine materials to provide a service.

In additional implementations, certain industries may employ industrial process 105 that include industry specific tasks. For example, when the industrial process 105 is performed as part of a mining industry, the industrial process 105 may involve the extraction of minerals and other geologic materials from the Earth and the refinement of the extracted materials for use as raw materials for other industries. In particular, when the industrial process 105 is performed within the mining industry, tasks may include exploring tasks, extracting tasks, processing tasks, refining tasks, environmental managing tasks, and the like. When the industrial process 105 performed within the mining industry includes exploring tasks, the industrial process 105 includes tasks that identify the locations of likely mineral deposits. Exploring tasks include geological tasks (where surface geology is studied to predict subsurface conditions), geophysical tasks (where tasks are performed to detect subsurface anomalies), geochemical tasks (where tasks are performed to detect evidence of mineral deposits in samples), sensing tasks (where images are analyzed to predict the location of mineral deposits), and the like. Further, when the industrial process 105 performed within the mining industry includes extracting tasks, the industrial process 105 includes tasks that remove minerals from the Earth. Extraction tasks include surface mining tasks (where tasks are performed to remove minerals near the surface of the Earth), underground mining (where tasks are performed to remove minerals from deep beneath the surface), and the like. Moreover, when the industrial process 105 performed within the mining industry includes processing tasks, the industrial process 105 includes tasks for processing ores for refinement. Processing tasks include crushing tasks (where tasks are performed to reduce the size of ore), separation tasks (where tasks are performed to separate different minerals), and the like. Also, when the industrial process 105 performed within the mining industry includes refining tasks, the industrial process 105 includes tasks for producing extracted minerals. Refining tasks include smelting tasks (where ore is heated for the extraction of metal), chemical tasks (where chemical processes are performed to extract metals from ores), purifying tasks (where tasks are performed to remove impurities from extracted metals), and the like. Further, when the industrial process 105 performed within the mining industry includes environmental management tasks, the industrial process 105 includes tasks for controlling the impact of mining tasks on the environment. Environmental management tasks include tailings management tasks (where tasks are performed for controlling the impact of waste materials produced during the production of metals), treatment tasks (where tasks are performed for treating waste to remove impurities), reclamation tasks (where tasks are performed for restoring or repurposing mined land), and the like.

In further implementations, the industrial process 105 may be performed within oil-refinement industries, where the industrial process 105 involves the processing of crude oil into useable products that may include gasoline, diesel fuel, asphalt base, heating oil, kerosene, and other oil-derived products. In particular, when the industrial process 105 is performed within oil-refinement industries, tasks may include distilling tasks, converting tasks, treating tasks, blending tasks, environmental managing tasks, and the like. When the industrial process 105 performed within the oil-refinement industries includes distilling tasks, the industrial process 105 includes tasks that separate oil into different components based on boiling points. Distilling tasks include heating tasks (where crude oil is heated), distillation tasks (where different compounds are heated to different boiling points), collection tasks (where different compounds are collected), and the like. Further, when the industrial process 105 performed within the oil-refinement industries includes converting tasks, the industrial process 105 includes tasks that break down and combine hydrocarbons into desired compounds. Converting tasks may include cracking tasks (where hydrocarbons are broken down into smaller molecules), reforming tasks (where molecules are converted into different molecules), combining tasks (where smaller molecules are combined into larger molecules), and the like. Moreover, when the industrial process 105 performed within the oil-refinement industries includes treating tasks, the industrial process 105 includes tasks that remove impurities from petroleum products. Also, when the industrial process 105 performed within the oil-refinement industries includes blending tasks, the industrial process 105 includes tasks that mix different compounds to produce final products. Further, when the industrial process 105 performed within the oil-refinement industries includes environmental managing tasks, the industrial process 105 includes tasks to reduce the impact of the refinement process on the environment. Environmental Managing tasks include emissions control tasks (where tasks are performed to reduce air pollutants), treatment tasks (where contaminants are removed from waste products), safety tasks (where tasks are performed to prevent dangerous accidents), and the like.

In other implementations, the industrial process 105 may be performed within pharmaceutical industries, where the industrial process 105 involves the production of medications. In particular, when the industrial process 105 is performed within pharmaceutical industries, tasks may include discovery tasks, testing tasks, manufacturing tasks, quality control tasks, compliance tasks, and the like. When the industrial process 105 performed within the pharmaceutical industries includes discovery tasks, the industrial process 105 includes tasks to identify molecules that could be medicinal. Discover tasks include targeting tasks (where tasks are performed to identify a biological target), identification tasks (where tasks are performed to find molecules that affect targets), screening tasks (where tasks are performed to screen identified molecules), and the like. Further, when the industrial process 105 performed within the pharmaceutical industries includes testing tasks, the industrial process 105 includes tasks to test the impact of molecules on biological targets. Testing tasks include preclinical tasks (where testing is performed through chemical and biological methods), clinical tasks (where testing is performed on potential end users, approval tasks (where testing data is provided to regulatory bodies for approval), and the like. Moreover, when the industrial process 105 performed within the pharmaceutical industries includes manufacturing tasks, the industrial process 105 includes tasks to produce medicine for consumers. Manufacturing tasks include synthesizing tasks (where tasks are performed to produce the desired molecules), formulation tasks (where tasks are performed to create a final drug product from the molecules), and the like. Also, when the industrial process 105 performed within the pharmaceutical industries includes quality control tasks, the industrial process 105 includes tasks to assure the quality of produced medications. Quality control tasks include adherence tasks (where tasks are performed to ensure products are consistent), validation tasks (where tasks are performed to ensure produced medicine continues to satisfy desired performance), and the like. Further, when the industrial process 105 performed within the pharmaceutical industries includes compliance tasks, the industrial process 105 includes tasks to ensure that medications comply with regulations. Compliance tasks include documentation tasks (where tasks are performed to gather documentation related to the medication), inspection tasks (where tasks are performed to support regular audits), and safety tasks (where tasks are performed to ensure the continued safety of the medicine).

In further embodiments, to perform the industrial process 105 at the site 101, the system 100 may include one or more sensors 107, one or more actuators 108, and one or more controllers 106. As used herein, the sensors 107 and actuators 108 represent components or equipment in an industrial system that perform one or more of a wide variety of functions associated with a process 105. In particular, as used herein, the sensors 107 include equipment that can measure or evaluate a wide variety of characteristics of the industrial process 105. For example, the sensors 107 may measure characteristics that include flow, pressure, temperature, inventory levels, material compositions, and other measurable characteristics of the industrial process 105.

In additional embodiments, where the sensors measure information about the industrial process 105, the one or more actuators 108 include equipment that is controllable to perform one or more steps of the industrial process 105. For example, the actuators 108 may include distillation columns, cracking equipment, smelters, or other equipment that can perform steps in industrial processes 105 in various industrial domains. Additionally, the one or more actuators 108 may include equipment that controls one or more characteristics of the industrial process 105. For example, the one or more actuators 108 may include valves that are controllable to control the amount of material provided for a process. the process system, such as valve openings.

In further embodiments, the system 100 may include one or more controllers 106 located at the site 101 or located remotely to the site 101 but communicatively connected to equipment located at the site 101. The one or more controllers 106 can be used within the system 100 to control the performance of various functions that are part of the one or more industrial processes 105. For example, a first set of controllers 106 may use measurements from one or more sensors 107 to control the operation of one or more actuators 108. A second set of controllers 106 could then be used to optimize the control logic or other operations performed by the first set of controllers. A third set of controllers 106 could perform additional functions related to the industrial process 105. The controllers 106 could, therefore, support a combination of approaches, such as regulatory control, advanced regulatory control, supervisory control, and advanced process control.

In some embodiments, each controller 106 may include any suitable structure for controlling one or more aspects of an industrial process. At least some of the controllers 106 could, for example, represent proportional-integral-derivative (PID) controllers or multivariable controllers, such as controllers implementing model predictive control (MPC) or other advanced predictive control (APC). In a particular example, each controller 106 could represent a computing device running a real-time operating system, a WINDOWS operating system, a LINUX operating system, or other operating system.

In additional embodiments, at least one of the controllers 106 could denote a controller that operates according to a predetermined process model. For example, a control model may control the controllers 106 to operate using one or more process models to determine, based on measurements from one or more sensors 107, how to adjust one or more actuators 102 to control the performance of the process 105 according to the process model. In some embodiments, each model that directs the operation of the controllers 106 may direct the controllers 106 to be responsive to various process variables that could include information acquired from the sensors 107 or information about the operation of the one or more actuators 108.

In some embodiments, a process manager or other user 110 may interact with the process 105. The user 110 may control the industrial process 105 by interacting with the equipment that performs one or more of the steps of the industrial process 105. Additionally, the user 110 may perform some of the sensing functions similar to the functions provided by the sensors 107. For example, the user 110 may acquire samples of materials used within or produced by the industrial process 105.

In some embodiments, the system 100 may include at least one network that enables electronic communications between various components located at the site 101 associated with the performance of the one or more industrial processes 105. For example, the sensors 107 and the actuators 108 may be connected to a network 104, where the network 104 connects the sensors 107 and the actuators 108 to the one or more controllers 106. Additionally, the network 104 may be connected to a human-machine interface through which the user 110 can interact with the industrial process 105. Accordingly, the user 110 may communicate through the human-machine interface to control or send communications associated with the industrial process 105 through the network 104. The network 104 may be implemented as any suitable network or combination of networks. For example, the network 104 may be one or more of an Ethernet network, an electrical signal network, a pneumatic control signal network, a wireless network, or any other type of network.

In certain embodiments, the network 104 may connect the site 101 to other locations that have an interest in information produced at the site 101 or by sending instructions to control the industrial process 105 performed at the site 101. In particular, the network 104 may connect the site 101 to an analysis environment 103. The analysis environment 103 may include equipment to enable the analysis and evaluation of the industrial process 105. The network 104 may acquire information from at least one of the sensors 107, the user 110, the controllers 106, and the actuators 108, among other components, and provide the acquired information to the analysis environment 103. The analysis environment 103 then uses the acquired information to analyze and evaluate the industrial process 105. In some instances, the analysis environment 103 is located remotely from the site 101. In other instances, the analysis environment 103 may be located adjacent to or as part of the site 101.

In some embodiments, the analysis environment 103 may include one or more processors 113 that are used to perform analysis of the industrial process 105. The one or more processors 113 may acquire data from a memory 115, where the data may include computer-readable data that the one or more processors 113 may use to perform analysis of the industrial process 105. For example, the memory 115 may include instructions executed by the one or more processors 113 and data operated on when the one or more processors 113 executes the instructions. In particular, the memory 115 may include a measurement repository 117. As used herein, the measurement repository 117 may be a data structure that can store information acquired from the site 101. In particular, the one or more processors 113 may receive information from the site 101 through the network 104 and store the received information in the measurement repository 117.

In certain embodiments, the measurement repository 117 may be a data structure for associating various measurements and parameters associated with the control and analysis of the industrial process 105. In particular, the measurement repository 117 may be a database that employs a key performance indicator (KPI) tag system. When the measurement repository 117 employs a KPI tag system, the processors 113 may execute the KPI tag system that collects a list of tag names and data values for storage in the database within the measurement repository 117. For example, the KPI tag system detects primary KPIs from the tag names and process values. The KPI tag system of the method further detects secondary KPIs from the tag names and process values, extracts a set of KPI tags from the primary and secondary KPIs, and stores the extracted KPI tags in the memory.

In further embodiments, computing systems, within the analysis environment 103 or the site 101, execute the KPI tag system to support the operation and control of the industrial process 105. The KPI tag system collects the list of tag names and process data from the database and detects primary KPIs from the list of the collected tag names and process data. The KPI tag system further detects secondary KPIs from the list of tag names and process data and extracts a set of KPI tags from the primary and secondary KPIs to store the extracted KPI tags in the memory 115.

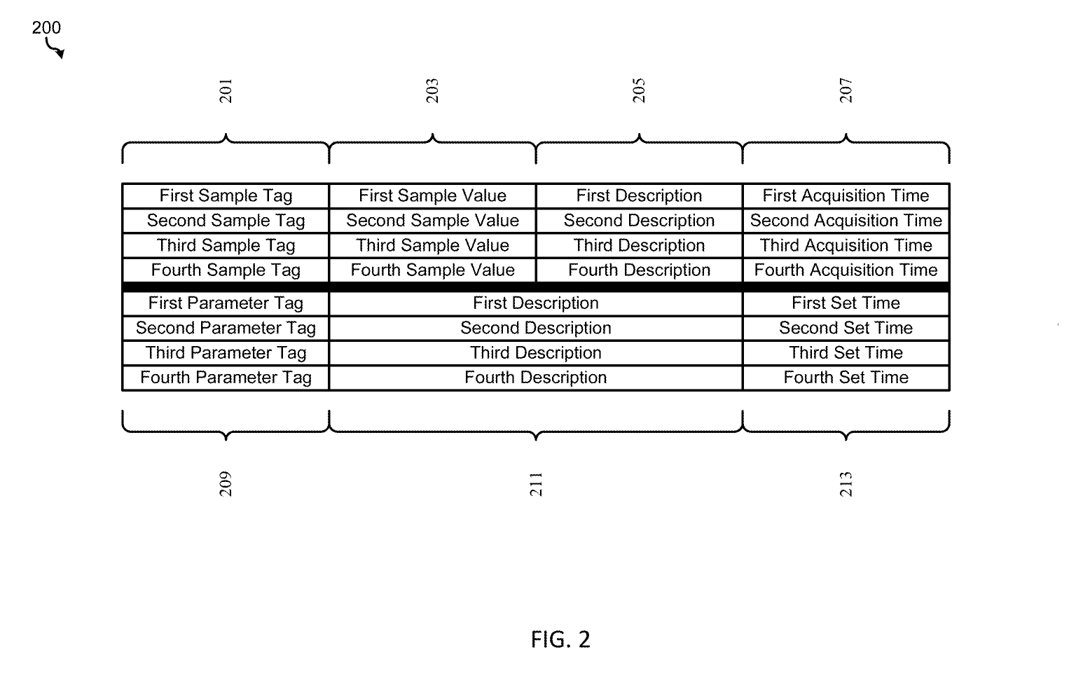

FIG. 2 illustrates an exemplary illustration of a table 200, where types of data are stored within the measurement repository 117 that associates process data and parameters within a tag system. For example, the table 200 may associate measurements of data acquired from the industrial process 105 with sample tag 201. For example, the sample tag names may contain enough information to help a user understand the types of information contained therein and how the associated information fits within a larger process architecture. For example, the sample tag names may tie the information in the measurement repository 117 associated with a specific sample tag name to codes shown on process and instrumentation diagrams (or other diagram) to help a user identify a location within the process equipment associated with the collection of information tied to the sample tag. Also, a sample tag may tie the data associated with the sample tag to other types of information. For example, the sample tag may tie to other information that includes data types (e.g., real, integer, discrete), data flow (e.g., input, output), usage (e.g., input/output, temporary variable, index counter), scope (e.g., local, global), process parameter (e.g., pressure, flow, temperature), and location usage (e.g., engine, compressor, turbocharger).

In further embodiments, the table 200 may store various information associated with the sample tags 201. For example, data associated with the sample tags 201 may include sample values 203, sample descriptions 205, sample acquisition times 207, and other data that may be reasonably associated with the sample tags. In particular, the sample values 203 may represent measurement data acquired from the sensors associated with a sample tag. The sample descriptions 205 may represent data that provides additional description information for the sample tag. The sample acquisition times 207 may represent data that identifies the time when the measurement associated with the sample tag was acquired. The table 200 may also include other information associated with the sample tag that can be used in the performance of analysis of the process 105 or for determining when a measurement is stale.

In additional embodiments, the table 200 may also store various information associated with process parameter tags 209. As used herein, a process parameter tag may represent settings and other configurable aspects of the process 105. For example, parameters may be associated with flow rates, input compositions, material amounts, temperatures, pressures, time settings, and the like. The names of the parameter tags 209 may be descriptive of the setting associated with the parameter. Also, the name of a parameter tag 209 may describe a location or equipment in the process that is associated with the process parameter. In addition to the process parameter tag 209, the table 200 may also include additional information to help a user or other individual understand the parameters of the process associated with the process. Also, the table 200 may include set times 213, where the set times describe when the associated parameter was last configured.

In additional embodiments, as described in FIG. 1, the analysis environment 103 may store information associated with a measurement prediction model 119. The measurement prediction model 119 may be a computer-executable model that can generate measurement predictions that represent potential states of the industrial process 105. In some embodiments, the measurement prediction model 119 may be a machine learning model, a statistic model, or other model type capable of generating measurement predictions. While the measurement prediction model 119 is illustrated as being stored in the memory 115. The measurement prediction model 119 may be hosted on the cloud or executed remotely. For example, the processors 113 may provide input information for the measurement prediction model 119 to the measurement prediction model 119 by either executing the measurement prediction model 119 directly or by providing the input information to another processor that executes the measurement prediction model 119 and provides measurement predictions to the processors 113.

In certain embodiments, the measurement prediction model 119 generates measurement predictions. The measurement predictions are predictions of a current state of one or more measurable characteristics of the industrial process 105 being performed on the site 101. The measurement predictions may be used by the processors 113 to replace stale measurements in the measurement repository. The measurement predictions may then be used in conjunction with non-stale measurements to perform an analysis of the industrial process 105. In some embodiments, the processors 113 may execute an analysis program that uses combinations of the measurement predictions and the non-stale measurements when performing the analysis of the industrial process 105. Additionally, or alternatively, an analyst 111 may use the processors 113 through a user interface to acquire a combination of the measurement predictions and the non-stale measurements to perform an analysis of the industrial process 105. With respect to FIG. 2, information associated with the parameter tags 209 and sample tags 201 may be provided as inputs to the measurement prediction model 119. The machine prediction model 119 may then generate measurement predictions that can be used to replace the information associated with sample tags 201 or create measurement predictions that can be optionally used for one or more of the sample tags 201. In some embodiments, the generated measurement predictions may be compared against the information in the sample tags 201 to perform validation of the measurement prediction model 119.

In additional embodiments, the processor 113 may determine whether a measurement in the measurement repository 117 is stale. When the 113 determines that a measurement is stale, the processors 113 may then use generated measurement predictions from the measurement prediction model 119 or may provide input to the measurement prediction model 119 to generate the measurement predictions to replace the stale measurements. In some implementations, the processors 113 may determine that a measurement is stale when a defined period of time has elapsed since the measurement was acquired from the site 101. Alternatively, the processors 113 may determine that a measurement is stale based on changes in other related measurements. Further, the processors 113 may determine that a measurement is stale based on an indication from the analyst 111. For example, the analyst 111 may provide information to the processors 113 through a user interface indicating that one or more measurements in the measurement repository 117 are stale. When the processors 113 determines that a measurement is stale, the processors 113 then use the measurement prediction model 119 in any subsequently performed analysis of the industrial process 105 within the analysis environment 103.

In certain embodiments, the measurement prediction model 119 is produced using machine learning. As used herein, machine learning generally refers to computational methods for automating data analysis that enables computing systems to learn from data, identify patterns, and make decisions or generate additional information with minimal human intervention. Further, models produced using machine learning methods may be capable of improving performance over time as they adapt to additional data. Generally, machine learning model training is performed using one or more various learning paradigms. These learning paradigms include supervised learning, unsupervised learning, and reinforcement learning. When training the measurement prediction model 119, the processor 123 may use a combination of learning paradigms.

When a machine learning model, such as the measurement prediction model 119, is trained using supervised learning, the model is trained using labeled datasets. In particular, the training data 127 may include a dataset labeled where the inputs to a model are known, and the output that the model should produce in response to the known inputs is also known. Thus, during training, the measurement prediction model 119 learns the relationship between the input data and the desired output. As the measurement prediction model 119 learns the relationship between the input data and associated outputs, the measurement prediction model 119 may improve its ability to make generalized predictions upon receiving new unseen or non-labeled data. Various machine learning algorithms may be used to train a model using supervised learning. These algorithms may include combinations of decision trees, support vector machines (SVM), neural networks, and the like.

When a machine learning model, such as the measurement prediction model 119, is trained using unsupervised learning, the learning is focused on identifying patterns in input data that lack labeled outputs. For example, in contrast to learning relationships between inputs and outputs, the measurement prediction model 119 may learn to organize data into groups or clusters based on similarities or hidden structures. Various machine learning algorithms may be used to train a model using unsupervised learning. These algorithms include clustering, principal component analysis, and dimensionality reduction, among other unsupervised learning techniques.

When a machine learning model, such as the measurement prediction model 119, is trained using reinforcement learning, the measurement prediction model 119 learns through interaction with data received from outside the model and then receives feedback in the form of rewards or penalties through the interactions. Through these interactions, the model learns to perform actions associated with rewards and to avoid actions associated with penalties. Reinforcement learning is an effective tool for training a model that performs decision-making and also for optimizing actions over time.

As illustrated, the measurement prediction model 119 may be trained within a training environment 121. However, the training of the measurement prediction model 119 may be performed in a variety of processing environments. For example, the measurement prediction model 119 may be trained on a local computing system subsequently distributed to the analysis environment 103, or the measurement prediction model 119 may be trained on a cloud-based platform. In some implementations, the training environment 121 and the analysis environment 103 may be the same environment. For example, the training environment 121 may be a cloud-based platform, and the measurement prediction model 119 is deployed within the same cloud-based platform. Often, the selection of the processing environment for the measurement prediction model 119 depends on the computational complexity of the measurement prediction model 119 and the size of the training data 127.

Where the training environment 121 is a local computing environment, the processors 123 and memory 125 may be implemented on one or more locally operating computers, such as workstations or servers. Often, workstations and servers used to train machine learning models include one or more high-performance CPUs or GPUs. However, local environments are often constrained in their processing capabilities and are generally used for training smaller-scale models or initial testing of machine learning algorithms. In contrast, where the training environment 121 is a distributed system, the processors 123 and memory 125 are implemented within multiple computing devices (like workstations and servers) distributed across one or more locations. Further, the multiple computing devices often train the measurement prediction model 119 using parallel computation. These distributed processors 123 and memory 125 are often suitable for training models with larger datasets and complexity. Further, the training environment 121 may be a cloud-based platform. As used herein, a cloud-based platform may refer to a service provided through the cloud that offers scalable resources for training and deploying machine learning models.

In certain embodiments, when training the measurement prediction model 119, the processors 123 may execute instructions that implement algorithms developed using a variety of programming languages and specialized libraries. For example, a model developer 129 may use programming languages such as Python, R, Java, C++, and Matlab, among others, which offer different benefits. For example, the model developer 129 may use Python because it supports many libraries that facilitate the implementation of machine learning models. A model developer 129 may use R to perform statistical analysis through libraries that are optimized for data exploration and modeling. The model developer 129 may use Java for its scalability and production-ready solutions. Further, the model developer 129 may use C++ when the measurement prediction model 119 requires low-level memory management. Matlab may also be used to perform research into machine learning algorithms, prototyping, and data visualization. Other programming languages can be used as well, depending on the characteristics of the training of the measurement prediction model 119.

As described herein, the measurement prediction model 119 may be trained using a single machine learning algorithm. Alternatively, the measurement prediction model 119 may be trained as a machine learning ensemble that combines multiple learning algorithms to produce a single model. By using a machine learning ensemble, the training of the measurement prediction model 119 may aggregate the strengths of different learning algorithms and paradigms to achieve a higher model accuracy than would be available using a signal model.

In some embodiments, when the measurement prediction model 119 has been trained within the training environment 121, the measurement prediction model 119 may be deployed to the analysis environment 103 for use in generating measurement predictions to replace stale measurements in the measurement repository 117. After deployment, information generated by the performance of analysis within the analysis environment 103 and generated by acquiring data from the industrial process 105 may be provided to the training environment 121 for the performance of additional training and validation of the measurement prediction model 119. For example, the information provided to the training environment 121 may include measurements, indications of stale data, measurement predictions, process parameters, and other data that can be used for the training and validation of the measurement prediction model 119. Thus, the performance of the measurement prediction model 119 may be improved as the measurement prediction model 119 is used.

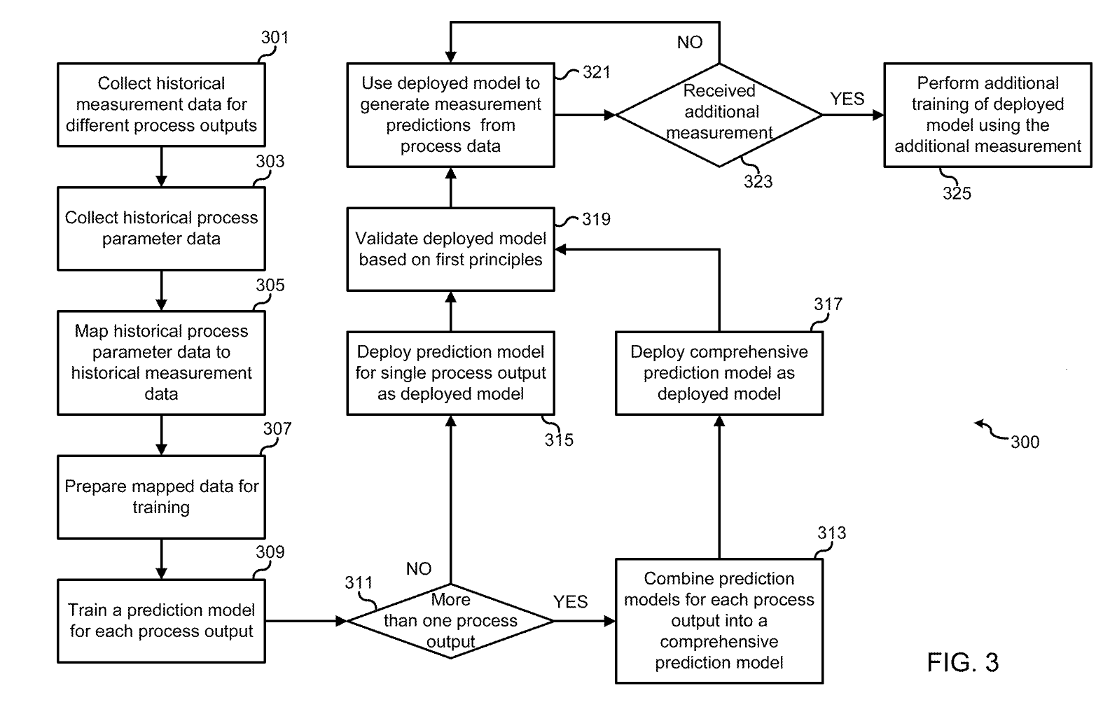

FIG. 3 is a flowchart diagram illustrating a method 300 for training and deploying the measurement prediction model 119 described in FIG. 1. In particular, the method 300 may proceed at 301, where historical measurement data is collected for different process outputs. For example, a data scientist (such as the model developer 129 in FIG. 1) may collect measurement information that can be used to train the measurement prediction model 119. For example, the data scientist may acquire historical measurement data representing sensor measurements collected from one or more processes. For example, the data scientist may collect measurements from a particular process to be modeled when training a model to generate measurement predictions that are specific to a particular process. Alternatively, data scientists may acquire historical measurement data from multiple processes to train a model that can generate measurement predictions for industrial processes generally. Further, the data scientist may acquire historical measurement data from multiple processes, or a single process associated with a single measurement (or a subset of potential measurements) to generate a measurement prediction model trained to predict a single measurement (or a subset of potential measurements).

Additionally, the method 300 may proceed at 303, where historical process parameter data is collected. For example, a data scientist may collect parameter information representing various parameters used to control a process that can also be used to train the measurement prediction model 119. For example, the data scientist may acquire historical parameter data representing potential process parameters collected from one or more processes. For example, data scientists may collect parameters from a particular process to be modeled when training a model to generate measurement predictions specific to a particular process. Alternatively, the data scientist may acquire historical parameter data from multiple processes to train a model that can generate measurement predictions for industrial processes generally. Further, the data scientist may acquire historical parameter data from multiple processes, or a single process associated with a single measurement (or a subset of potential measurements) to generate a measurement prediction model trained to predict a single measurement (or a subset of potential measurements).

In some embodiments, the method 300 proceeds at 305, where the historical process parameter data is mapped to the historical measurement data. For example, historical measurement data may include information about time that represents when a particular measurement was acquired. In a similar manner, the historical parameter data may include time information representing the time when parameter data was acquired. After the times for the measurement data and parameter data are identified, the measurement data is associated with the parameter data with the closest times. By mapping the parameter data to the measurement data and then using the mapped data for training the measurement prediction model 119, the model may be trained to associate the parameter data with the measurement data in a time-dependent manner.

In additional embodiments, the method 300 proceeds at 307, where the mapped data is prepared for training. For example, after data has been collected and the inputs (parameter data and potentially some measurement data) have been mapped to the outputs (measurement data), the mapped data may be additionally prepared to enhance the performance, accuracy, and reliability of the subsequently trained machine learning models. Examples of potential steps performed to prepare the mapped data may include cleaning, data preprocessing, feature engineering, feature selection, data normalization and scaling, data augmentation, data splitting, data balancing, data storage and management, metadata documentation, and the like.

In some embodiments, the mapped data may be cleaned to enhance the quality and suitability of the mapped data for training. The cleaning of the data may include the handling of missing values in the historically gathered data. For example, holes may exist when measurement data lacks mappable parameter data and vice versa. When there are missing values in the data, the holes may be filled in using imputation methods like mean, median, or mode substitution, using interpolation processes like splines, regression analysis, and the like, along with other mathematical techniques that can create appropriate data for the missing values. Additionally, data cleaning may include removing data that can cause biases or inaccuracies in the resultant model. For example, data cleaning methods may identify and remove duplicate records to prevent the duplicate data from biasing the model. The data cleaning methods may also filter outliers from the data using statistical methods. Additionally, the data cleaning methods may correct or remove inaccuracies due to typographical errors and measurement faults, among other sources of information that can incorrectly distort the output of the resultant measurement prediction model.

In additional embodiments, when the mapped data has been cleaned, the cleaned data may then be preprocessed to transform the cleaned data into a format that is amenable to machine learning algorithms. Preprocessing steps may include encoding categorical variables into numerical form using techniques like one-hot encoding or label encoding, processing textual data through tokenization, stop word removal, stemming, and lemmatization, handling time-series data through resampling, detrending, or smoothing techniques, and the like.

In other embodiments, feature selection may be conducted to enhance model efficiency and prevent overfitting by selecting the most relevant features in the mapped data. Techniques used may include filter methods utilizing statistical tests to select features with strong correlations to the target variable, wrapper methods employing iterative algorithms that select features based on model performance, and embedded methods utilizing algorithms that perform feature selection during model training, such as Lasso regression. In some implementations, when the model is configured to provide outputs for multiple process measurements, feature selection may be performed for each process measurement or for groups of measurements.

Also, data normalization and scaling may be applied to standardize the data, ensuring that each feature contributes equally to the model. This may involve normalization using min-max scaling to scale features to a specific range, typically between zero and one, standardization to adjust features to have a mean of zero and a standard deviation of one, and log transformation to handle skewed distributions. The data may also be augmented to increase the diversity and size of the dataset without the need to collect new data. Data augmentation techniques may include synthetic data generation methods, such as employing Generative Adversarial Networks (GANs) or other techniques to create artificial data samples.

When the data has been prepared, it can be divided into different groups, where each group serves a different purpose in the training of the measurement prediction model 119. For example, the prepared data may be divided into training sets, validation sets, and testing sets. Typically, the testing data set may include 60-80% of the data and is used to perform the original training of the model. The validation set is then used to perform hyper-parameter tuning and model selection, and the testing data is held out to assess the final model performance using data that has not been used in the training or validation of the measurement prediction model 119.

When the mapped data has been prepared for training, the method 300 may proceed at 309, where the measurement prediction model 119 is trained for each process output. Alternatively, the measurement prediction model 119 may be trained for multiple process outputs. However, when trained for each process output, model input associated with the desired process output is provided as input to a machine learning training algorithm. The machine learning algorithm then provides an output that is checked against an expected output associated with the provided input. The machine learning algorithm then adjusts model parameters to minimize the loss between the predicted output and the expected output. When the training algorithm attempts to create a model capable of generating multiple model parameters, the machine training learning algorithm may attempt to minimize the composite loss of the multiple parameters. As used herein, the machine learning training algorithm may be one or more algorithms suitable for machine learning. For example, machine learning algorithms may be neural network algorithms, transfer learning algorithms, autoencoders, ensemble tree methods, and the like. Further, after the model has been trained, the model may then be validated using the validation data and then tested using the testing data.

Further, the method 300 proceeds at 311, where it is determined whether the measurement prediction model 119 is for more than one process output. If the measurement prediction model 119 is for more than one process output, the measurement prediction model 119 is trained for the single output, and the method 300 proceeds at 315, where the measurement prediction model 119 is deployed as the deployed model. As described above, the deployed model may be deployed into a cloud environment, a server environment, or for use stored on a local machine. In alternative implementations, where the measurement prediction model 119 is trained for more than one process output, the prediction models for each process output may be used at 313, where the prediction models for each process output are combined into a comprehensive prediction model. For example, the different process outputs may be trained using separate models with an ensemble tree-based method or another suitable learning algorithm, and then the separate models may be combined into a single prediction model that outputs all the composition’s proportions. For example, a recursive convolution network or a feed-forward neural network may be used to provide a vector output for the different process outputs from a combination of the separately trained models. Further, when the comprehensive model is trained, the method 300 proceeds ate 317, where the comprehensive prediction model is deployed as the deployed model.

After training, the method 300 proceeds at 319, where the deployed model is validated based on first principles. While method 300 shows the first-principles-based validation occurring after deployment, the first-principles-based validation may also be performed before deployment. As used herein, first-principles-based validation refers to a machine-learning hybrid approach that combines machine-learning techniques such as those described above with fundamental physical principles derived from domain-specific knowledge. For example, the domain-specific knowledge may be rooted in physics, chemistry, biology, or other sciences. Using first-principles-based validation techniques leverages the benefits of data-driven models and scientific laws and equations to develop more accurate, interpretable, and generalizable models for producing the desired process outputs.

When performing validation using first principles, scientific principles and equations can be used to identify acceptable ranges of outputs and predictions based on the input parameters. In particular, models may be built based on the application of mathematical models, where the mathematical models are merged into the machine learning models. First-principles-based models can be integrated with the machine learning models using physics-informed machine learning, where the physical laws are embedded directly into machine learning models. As such, the first principles may define an acceptable range of outputs based on inputs to the machine learning model. The outputs predicted by the model are then bound within the acceptable range. Other integration techniques may include hybrid models, data-driven discovery of first principles, regularization, surrogate modeling, and the like. As described, the first-principles-based modeling may be used during initial training, during pre-deployment validation, and after deployment to ensure that the measurement prediction model 119 provides measurement predictions that comport with the physical laws that govern the associated industrial processes.

In certain embodiments, when the model has been deployed, the method 300 proceeds at 321, where the deployed model is used to generate measurement predictions from process data. For example, as measurement data becomes stale or otherwise is believed to be misrepresenting the current state of an industrial process under analysis, the measurement prediction model 119 may receive inputs and generate outputs that can replace stale or missing measurements. The inputs to the model may include process parameters, recent measurement data, time information, or other information related to the execution of a respective industrial process. The outputs of the deployed model may represent one or more measurement predictions that can be used to replace the stale measurements when performing an analysis of the process or used for other purposes related to the process. Accordingly, by using the generated measurement predictions from a deployed measurement prediction model 119, subsequently performed analysis may more accurately represent the actual industrial process 105.

In some embodiments, after the deployed model has been used to generate measurement predictions, the analysis environment may receive actual measurements associated with the generated measurement predictions. Accordingly, the method 300 may proceed at 323, where the method 300 determines whether additional measurements have been received from the site. If no additional measurements have been received, the method 300 returns to 321, where the generated measurement predictions are used in place of stale measurements. However, when additional measurements have been received, the additional measurements are used when performing analysis to replace the associated generated measurement predictions and previously received associated measurements. For example, the sensors and other sources of information at the site that provide actual measurements of the industrial process may provide additional measurements. As recently received measurements from the site represent the actual state of the industrial process, the received measurements are likely more accurate than the generated measurement predictions and previously received measurements. Thus, additional measurements are then used to analyze the process.

Further, when additional measurements are received, the method 300 may proceed at 325, where additional training of the deployed model may be performed using the additional measurements. For example, the additional measurements may be provided to the training environment 121 where the additional measurements may be used to further validate the deployed measurement prediction model 119. In addition to providing the additional measurements to the training environment 121, other information may be provided to the training environment 121 that can further validate the deployed measurement prediction model 119. For example, the other information may include actual process parameters, other related measurements, associated generated measurement predictions, measurements that have been identified as stale, time information, and other information that could be related to the measurement prediction model 119 and the relationship between the measurement prediction model 119 and the additional measurements. Accordingly, the additional measurements may be used to improve the predictions generated by the measurement prediction model 119.

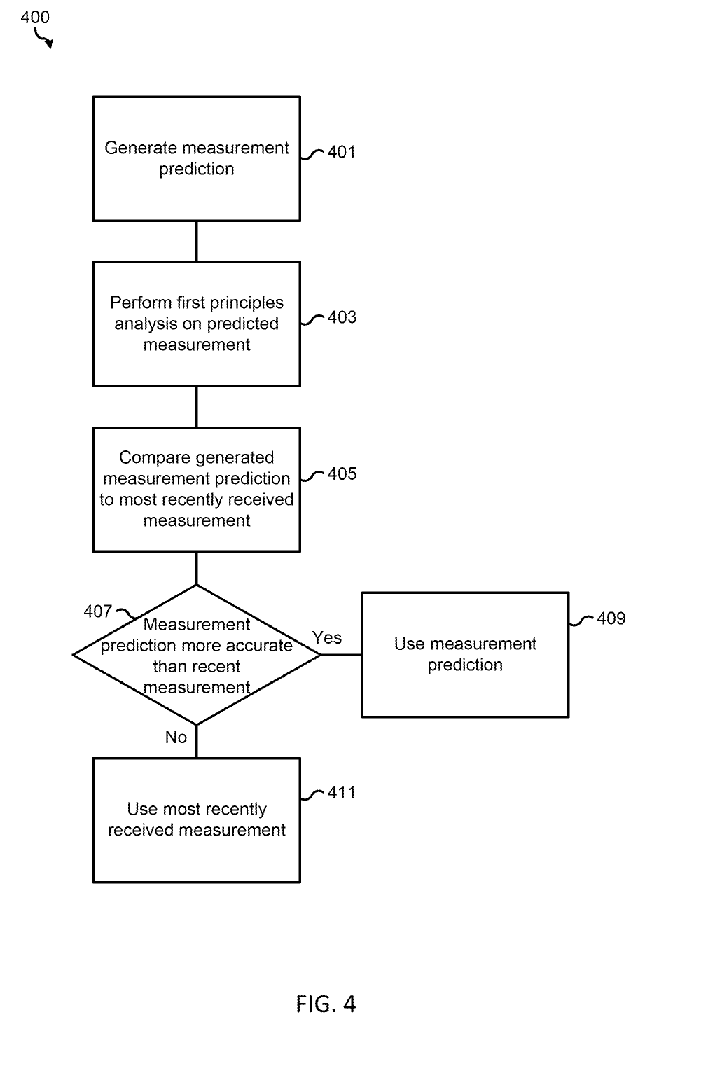

FIG. 4 is a flowchart diagram of a method 400 for determining whether to use a generated measurement prediction produced by a measurement prediction model 119. In particular, the generated measurement prediction may be more or less accurate than a stale measurement. Thus, the method 400 may compare the generated measurement prediction to saved previously received measurements and determine which measurement to use to analyze the industrial process 105. In particular, the method 400 proceeds at 401, where the measurement prediction is generated. In particular, the measurement prediction model 119 may generate a measurement prediction as described above.

In certain embodiments, to evaluate the accuracy of the generated measurement prediction, the method 400 may proceed at 403, where first principle analysis is performed on the predicted measurement. In particular, known process parameters and other known measurements may be subjected to a first principle analysis to identify a measurement or range of measurements that satisfy first principles. When the range of measurements that satisfies first principles is identified, the method 400 proceeds at 405, where the generated measurement prediction is compared to the most recently received measurement. For example, a generated measurement prediction, the previously received measurement, or previously generated measurement can be compared to one another with reference to the measurement or range of measurements that satisfy first principles. Additionally, the method 400 proceeds at 407, where it is determined whether the measurement prediction is more accurate than a recently received measurement. For example, if the generated measurement prediction is outside the range of measurements that satisfy first principles and the recently received measurement is within the range of measurements, the recently received measurement may be deemed to be more accurate. If both the generated measurement prediction and the recently received measurement are within the range of measurements that satisfy first principles, the generated measurement prediction may be deemed to be more accurate. The comparison may also include previously generated measurements.

In certain embodiments, when the generated measurement prediction is determined to be more accurate, the method 400 proceeds at 409, where the generated measurement prediction is used. For example, analysis of the process may use the generated measurement prediction to analyze an industrial process 105 instead of the most recently received measurement or a previously generated measurement prediction. Alternatively, when the most recently received measurement is determined to be more accurate, the method 400 proceeds at 411, where the most recently received measurement is used. For example, analysis of the process may use the most recently received measurement to analyze an industrial process 105 instead of the generated measurement prediction. In some further implementations, when the most recently received measurement is deemed more accurate, the most recently received measurement and associated parameter and process data may be provided to the training environment 121 for additional validation of the measurement prediction model 119.

In certain embodiments, the various systems and methods described above may be performed by hardware or through the execution of instructions performed by one or more processors. For example, the processor and/or other computational devices may be implemented using software, firmware, hardware, or an appropriate combination thereof. The processors or other computational devices may be supplemented by, or incorporated in, specially-designed application-specific integrated circuits (ASICs) or field programmable gate arrays (FPGAs). The processors and other computational devices can also include or function with software programs, firmware, or other computer-readable instructions for carrying out various process tasks, calculations, and control functions used in the methods and systems described herein.

The methods described herein may be implemented or controlled by computer-executable instructions, such as program modules or components, executed by the one or more processors or other computing devices. Generally, program modules include routines, programs, objects, data components, data structures, algorithms, and the like, which perform particular tasks or implement particular abstract data types.

Instructions for carrying out the various process tasks, calculations, and generation of other data used in the operation of the methods described herein may be implemented in software, firmware, or other computer-readable instructions. These instructions are typically stored on appropriate computer program products that include computer-readable media used to store computer-readable instructions or data structures. The computer-readable media may store computer-readable instructions or data structures. Such a computer-readable medium may be available media that can be accessed by a general-purpose or special-purpose computer or processor, or any programmable logic device.

Suitable computer-readable storage media may include, for example, non-volatile memory devices including semi-conductor memory devices such as Random Access Memory (RAM), Read Only Memory (ROM), Electrically Erasable Programmable ROM (EEPROM), or flash memory devices; magnetic disks such as internal hard disks or removable disks; optical storage devices such as compact discs (CDs), digital versatile discs (DVDs), Blu-ray discs; or any other media that can carry or store desired program code as computer-executable instructions or data structures.

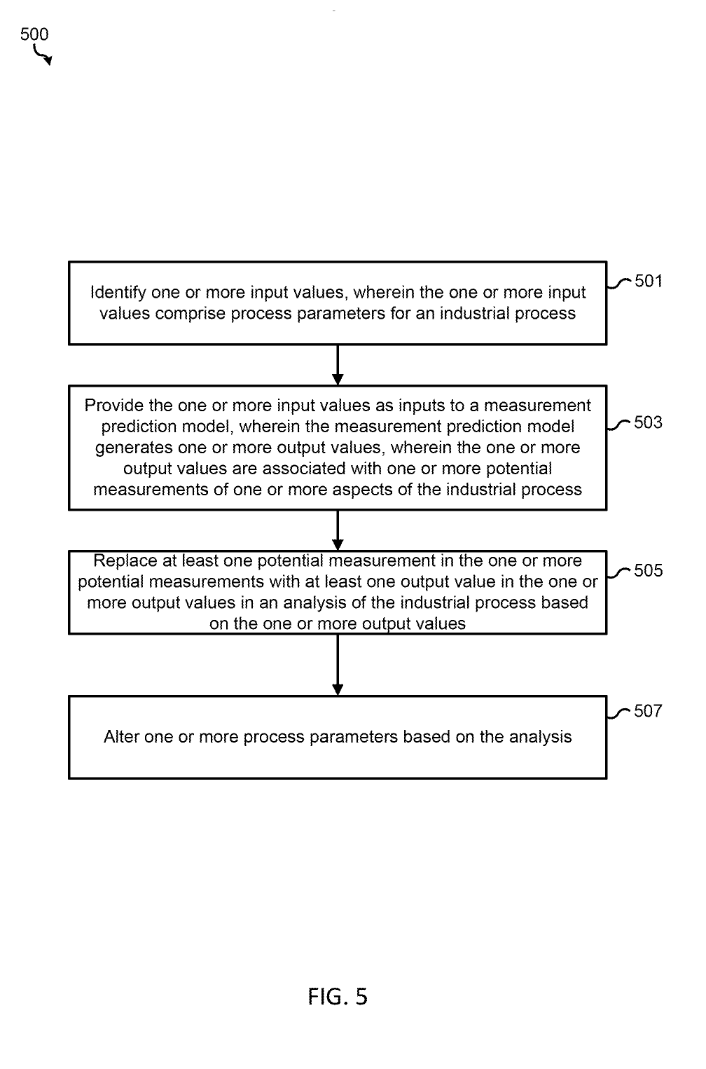

FIG. 5 illustrates a flowchart diagram of a method 500 for generating additional samples for industrial processes. The method 500 proceeds at 501, where one or more input values are identified, where the one or more input values comprise process parameters for an industrial process. Additionally, the method 500 proceeds at 503, where the one or more input values are provided as inputs to a measurement prediction model. Further, the measurement prediction model generates one or more output values that are associated with one or more potential measurements of one or more aspects of the industrial process. Moreover, the method 500 proceeds at 505, where at least one potential measurement in the one or more potential measurements is replaced with at least one output value in the one or more output values in an analysis of the industrial process based on the one or more output values. Additionally, the method 500 proceeds at 507, where one or more process parameters are altered based on the analysis. For example, the information derived from the analysis can be used to monitor and configure the controlling parameters of the industrial process to improve the performance of the industrial process.

### Example Embodiments

Example 1 includes a system comprising: a memory configured to store a model associated with a physical process, wherein the model is configured to receive one or more input values and provide one or more output values, wherein the one or more input values represent potential input parameters for the physical process and the one or more output values represent potential measures of process information; and one or more processors executing computer executable instructions that cause the one or more processors to: receive the one or more input values; generate the one or more output values by executing the model using the one or more input values as model inputs; provide the one or more output values to replace one or more measures based on samples acquired from the physical process; and analyze the physical process based on the one or more output values.

Example 2 includes the system of Example 1, wherein the model is also configured to receive the one or more measures based on the samples as part of the model inputs.

Example 3 includes the system of any of Examples 1-2, wherein the one or more processors are further configured to train the model.

Example 4 includes the system of Example 3, wherein the one or more processors are configured to train the model by: training multiple separate models based on the one or more input values for each value in the one or more output values; and combining the multiple separate models into a single model.

Example 5 includes the system of any of Examples 3-4, wherein the one or more processors are further configured to constrain the one or more output values to ranges associated with physically possible measures of the process information.

Example 6 includes the system of any of Examples 1-5, wherein one or more processors are further configured to validate the model using additional measures based on the samples acquired from the physical process.

Example 7 includes the system of any of Examples 1-6, wherein the one or more processors are further configured to: identify which of the one or more measures are stale measures; and replace the stale measures with associated output values in the one or more output values.

Example 8 includes a method comprising: identifying one or more input values, wherein the one or more input values comprise process parameters for an industrial process; providing the one or more input values as inputs to a measurement prediction model, wherein the measurement prediction model generates one or more output values, wherein the one or more output values are associated with one or more potential measurements of one or more aspects of the industrial process; replacing at least one potential measurement in the one or more potential measurements with at least one output value in the one or more output values in an analysis of the industrial process based on the one or more output values; and altering one or more process parameters based on the analysis.

Example 9 includes the method of Example 8, wherein the one or more input values further comprise the one or more potential measurements, wherein the one or more potential measurements are acquired from one or more sensors that sense information about the industrial process.

Example 10 includes the method of any of Examples 8-9, further comprising training the measurement prediction model.

Example 11 includes the method of Example 10, wherein training the measurement prediction model comprises: identifying the one or more output values; training a separate measurement prediction model for each of the one or more output values; and combining the separate measurement prediction model into the measurement prediction model.

Example 12 includes the method of Example 11, wherein training the separate measurement prediction model for each of the one or more output values, comprises validating at least one separate measurement prediction model using first principles.

Example 13 includes the method of any of Examples 11-12, wherein training the separate measurement prediction model for each of the one or more output values comprises using an ensemble tree method.

Example 14 includes the method of any of Examples 11-13, wherein combining the separate measurement prediction model into the measurement prediction model comprises training the measurement prediction model to output a vector for the one or more output values.

Example 15 includes the method of any of Examples 8-14, further comprising validating the measurement prediction model using additional measurements based on samples acquired from the industrial process.

Example 16 includes the method of any of Examples 8-15, wherein replacing the at least one potential measurement comprises: identifying one or more measurements in the one or more potential measurements that are stale measurements; and replacing the stale measurements with associated output values in the one or more output values.

Example 17 includes the method of Example 16, wherein identifying the one or more measurements that are the stale measurements comprises comparing the one or more output values to the one or more potential measurements based on first-principles.

Example 18 includes a system comprising: a site, wherein an industrial process is performed at the site, the site comprising one or more sensors configured to produce one or more measurements of one or more aspects of the industrial process; an analysis environment, wherein the analysis environment receives the one or more measurements from the site and stores one or more process parameters for the industrial process, the analysis environment comprising one or more processors configured to: identify at least one stale measurement in the one or more measurements; generate at least one measurement prediction associated with the at least one stale measurement, wherein the at least one measurement prediction are generated by a measurement prediction model; and use the at least one measurement prediction in place of the at least one stale measurement to perform an analysis of the industrial process.

Example 19 includes the system of Example 18, further comprising a training environment wherein the measurement prediction model is trained at the training environment before being deployed for use within the analysis environment.

Example 20 includes the system of Example 19, wherein at least one of the analysis environment and the training environment employ first-principles to validate the measurement prediction model.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

1. A system comprising:
a memory configured to store a model associated with a physical process, wherein the model is configured to receive one or more input values and provide one or more output values, wherein the one or more input values represent potential input parameters for the physical process and the one or more output values represent potential measures of process information; and
one or more processors executing computer executable instructions that cause the one or more processors to:
receive the one or more input values;
generate the one or more output values by executing the model using the one or more input values as model inputs;
provide the one or more output values to replace one or more measures based on samples acquired from the physical process; and
analyze the physical process based on the one or more output values.

2. The system of claim 1, wherein the model is also configured to receive the one or more measures based on the samples as part of the model inputs.

3. The system of claim 1, wherein the one or more processors are further configured to train the model.

4. The system of claim 3, wherein the one or more processors are configured to train the model by:
training multiple separate models based on the one or more input values for each value in the one or more output values; and
combining the multiple separate models into a single model.

5. The system of claim 3, wherein the one or more processors are further configured to constrain the one or more output values to ranges associated with physically possible measures of the process information.

6. The system of claim 1, wherein one or more processors are further configured to validate the model using additional measures based on the samples acquired from the physical process.

7. The system of claim 1, wherein the one or more processors are further configured to:
identify which of the one or more measures are stale measures; and
replace the stale measures with associated output values in the one or more output values.

8. A method comprising:
identifying one or more input values, wherein the one or more input values comprise process parameters for an industrial process;
providing the one or more input values as inputs to a measurement prediction model, wherein the measurement prediction model generates one or more output values, wherein the one or more output values are associated with one or more potential measurements of one or more aspects of the industrial process;
replacing at least one potential measurement in the one or more potential measurements with at least one output value in the one or more output values in an analysis of the industrial process based on the one or more output values; and
altering one or more process parameters based on the analysis.

9. The method of claim 8, wherein the one or more input values further comprise the one or more potential measurements, wherein the one or more potential measurements are acquired from one or more sensors that sense information about the industrial process.

10. The method of claim 8, further comprising training the measurement prediction model.

11. The method of claim 10, wherein training the measurement prediction model comprises:
identifying the one or more output values;
training a separate measurement prediction model for each of the one or more output values; and
combining the separate measurement prediction model into the measurement prediction model.

12. The method of claim 11, wherein training the separate measurement prediction model for each of the one or more output values, comprises validating at least one separate measurement prediction model using first principles.

13. The method of claim 11, wherein training the separate measurement prediction model for each of the one or more output values comprises using an ensemble tree method.

14. The method of claim 11, wherein combining the separate measurement prediction model into the measurement prediction model comprises training the measurement prediction model to output a vector for the one or more output values.

15. The method of claim 8, further comprising validating the measurement prediction model using additional measurements based on samples acquired from the industrial process.

16. The method of claim 8, wherein replacing the at least one potential measurement comprises:
identifying one or more measurements in the one or more potential measurements that are stale measurements; and
replacing the stale measurements with associated output values in the one or more output values.

17. The method of claim 16, wherein identifying the one or more measurements that are the stale measurements comprises comparing the one or more output values to the one or more potential measurements based on first-principles.

18. A system comprising:
a site, wherein an industrial process is performed at the site, the site comprising one or more sensors configured to produce one or more measurements of one or more aspects of the industrial process;
an analysis environment, wherein the analysis environment receives the one or more measurements from the site and stores one or more process parameters for the industrial process, the analysis environment comprising one or more processors configured to:
identify at least one stale measurement in the one or more measurements;
generate at least one measurement prediction associated with the at least one stale measurement, wherein the at least one measurement prediction are generated by a measurement prediction model; and
use the at least one measurement prediction in place of the at least one stale measurement to perform an analysis of the industrial process.

19. The system of claim 18, further comprising a training environment wherein the measurement prediction model is trained at the training environment before being deployed for use within the analysis environment.

20. The system of claim 19, wherein at least one of the analysis environment and the training environment employ first-principles to validate the measurement prediction model.
